(19) United States
(12) Patent Application Publication
(10) Pub. No.: US 2006/0043755 A1
(43) Pub. Date: Mar. 2, 2006

(54) Truck covering system

(75) Inventor: Richard J. Coughtry, Stuart, FL (US)

Correspondence Address: BANNER & WITCOFF, 1001 G STREET N W, SUITE 1100, WASHINGTON, DC, 20001, US

(73) Assignee: John Donovan Enterprises, Inc., Stuart, FL (US)

(21) Appl. No.: 11/214,042

(22) Filed: Aug. 30, 2005

Related U.S. Application Data
(60) Provisional application No. 60/605,378, filed on Aug. 30, 2004.

(51) Int. Cl. B60P 7/02

(52) U.S. Cl. 296/100.1

(57) ABSTRACT

An apparatus and method for covering a top of an open container is provided that includes a cover and an actuator assembly. The actuator assembly may contain rigid linkages the can be pivotally connected and can move a lid assembly and cover over the open container. Movement of the lid assembly over the open container may cause covering and/or uncovering of the open container.

### The application claims the benefit of U.S. Provisional Application No. 60/605,378, filed Aug. 30, 2004, which is incorporated herein in its entirety.

### TECHNICAL FIELD

Features described herein relate to covers for open top truck trailers, truck beds, and more particularly to a side-to-side truck cover system.

### BACKGROUND ART

Open-top cargo containers such as trucks, trailers or storage bins can be used to carry loose loads. However, such transportation of loose loads, including sand, gravel or other waste in an open top cargo container can be hazardous if the load escapes from the container. Portions of the load can become dislodged (e.g., by wind, inertia, etc.) and accidentally spill out of the container, for example, during transport of the load in a truck. These spilled particles can cause damage to other vehicles and can cause obstruction of traffic or subsequent highway accidents as other vehicles attempt to circumvent the debris on the roadway. The risk of damage is intensified through effects of the wind. For instance, lightweight materials, such as plant clippings being taken to a landfill, mulch materials, or harvested plants like cotton, are liable to having gusty winds blow portions of the contents out of the vehicle or bin.

Hence it is beneficial for individuals transporting such loads to cover their loads. Indeed, in many jurisdictions, trucks and trailer loads carrying loose loads are required by law to cover their loads.

The most common conventional covering system is a manual tie down system of cords attached to a tarpaulin. The manual tie down system requires the vehicle operator to climb to the open top container and secure the cords after the cargo is loaded. It also requires undoing the cords just before the tarpaulin is uncovered prior to unloading the cargo. This is a very time consuming, and potentially hazardous, process for the vehicle operator.

In one scheme, a tarpaulin rack-and-pinion cover system is used to cover a truck or trailer load. In this system, a roller is operably connected to a mechanical arm with an attached flexible tarpaulin and is rotatably mounted on an open truck bed or trailer. Movement of a hydraulic axle (i.e., rack) in communication with the roller causes rotational movement of the roller or gear (i.e., pinion). The rotational movement of the roller or gear causes movement of the mechanical arm which, in turn, causes the flexible tarpaulin to cover the trailer load.

Similarly, movement of the hydraulic axle in the opposite direction causes the mechanical arm and the flexible tarpaulin to move away (i.e., uncover) the trailer load. In covering the trailer load, the tarpaulin is affixed to one top, longitudinal edge of the truck body. The opposite edge of the tarpaulin extends across the top of the truck body.

However, the rack-and-pinion arrangement requires frequent maintenance which a user often neglects to do. Often, users do not remember when maintenance is due and miss important maintenance milestones. When using a rack-and-pinion system, failing to maintain the system may be disastrous as the components may become irreparably damaged. For example, a user must periodically provide lubricant to the system for proper operation. If insufficient lubricant is provided to the rack-and-pinion components, damage may occur to the components as they move over each other. In severe situations, the components may fail altogether. Hence, a system that is essentially maintenance-free is desirable such that a user need not remember when maintenance is due.

In addition, there are numerous components within the rack-and-pinion system. To achieve the proper orientation of the mechanical arm movements and to obtain the proper direction of movement of the tarpaulin when opening or closing the cover, additional rotational components in the rack-and-pinion system must be used. These additional components are costly to implement as additional costs are associated with each added component. This is especially true with use of costly gears in the rack-and-pinion system. Also, as the number of components increases, the apparatus increases in size. The larger size of the apparatus or system may be subject to increased accidental trauma as compared to a compact apparatus. Hence, a compact system with fewer components that are more cost-effective is desirable.

In a rack-and-pinion system, the rotational components of the system are subject to large numbers of rotations per use. For example, when the tarpaulin is moved from a closed state to an opened state, depending on the diameter of the rotational components, the rotational components may rotate 10-20 revolutions. This creates additional wear on these components as compared to components that have more restrictive movements. A system is desirable that utilizes components in which excessive movement is not necessary. Such a system would have increased longevity and decreased maintenance costs.

Also, the tarpaulin must cover the entire truck load and therefore, a large sheet of tarpaulin is used in the conventional system. Such a tarpaulin can be very bulky. This large sheet of tarpaulin is further subject to forces from wind shear and aeronautic effects. When traveling, trucks hauling these containers create turbulent airflow at their headend that undulates the tarpaulin as the turbulent air passes over it. In addition, low pressure on the open side of the container creates lift on the tarpaulin, which acts like an airfoil. The turbulent air and low pressure periodically lift the tarpaulin upwards when the vehicle is in motion. The reduced spring tension coupled with the undulating, upward motion of the tarpaulin often permits the tarpaulin to expose partially the open top container and, in some extreme cases, can catastrophically damage the arms, tarpaulin and other components of the automated tarpaulin system. Even when actual damage does not occur, the increased stress on the system decreases longevity of the system and causes excessive wind drag on the truck. In addition, there is an increased risk of accidental opening of the cover which can result in damage to the truck, apparatus or an individual in the vicinity. Therefore, a system is desirable that provides a less bulky cover that is less susceptible to forces from the wind.

### SUMMARY OF EMBODIMENTS

The embodiments described herein include an actuator and lid assembly for a cover of a truck. In some embodiments, the actuator assembly comprises a base, linear actuator (such as a hydraulic cylinder), two-linkage mechanism, an actuator arm and one or more rollers. The lid assembly can contain a lattice structure, hinges, and roller track. The flexible tarpaulin may be attached onto the lattice structure. The lid may be pivotally connected to the top side(s) of the truck, and the roller of the actuator assembly may be engaged with the roller track of the lid assembly.

Accordingly, in one example, an assembly is provided containing at least one rigid linkage that covers an open top container such as a bed of a truck from side to side.

In another example, an assembly is provided which provides selective, powered control over covering and uncovering the load bed of a plurality of lid assemblies.

These and other features and advantages are readily apparent from the following detailed description and accompanying drawings.

### BRIEF DESCRIPTION OF DRAWINGS

FIG. 1 is a perspective view of a truck bed/trailer including an apparatus for covering a bed of the truck illustrating features described herein shown while in a covered position;

FIG. 2 is a close up view of a portion of the actuator assembly for the apparatus of FIG. 1 shown without the tarpaulin;

FIG. 3 is an exploded view of the actuator assembly of FIG. 2;

FIG. 4 is a close up view of a portion of a hinge and lattice structure of the lid of FIG. 1 shown without the tarpaulin;

FIG. 5 is a perspective view of the lid assembly of FIG. 1 shown while in a semi-covered position;

FIG. 6 is a close up view of a portion of the actuator assembly of FIG. 1 shown while in a semi-covered position and without the tarpaulin;

FIG. 7 is a perspective view of the truck bed/trailer of FIG. 1 shown while in a fully opened position and without the tarpaulin;

FIG. 8 is a perspective view of a truck bed/trailer including an apparatus with a single lid and actuator shown without a tarpaulin;

FIGS. 9A and 9B are top views of a truck bed/trailer including an apparatus with a plurality of lid assemblies.

FIG. 10 illustrates an example of opening the cover of FIG. 1 over a truck bed/trailer.

FIG. 11 further illustrates the example of FIG. 10 in which a second cover of the plurality of covers is opened.

### DETAILED DESCRIPTION

In the following description, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention

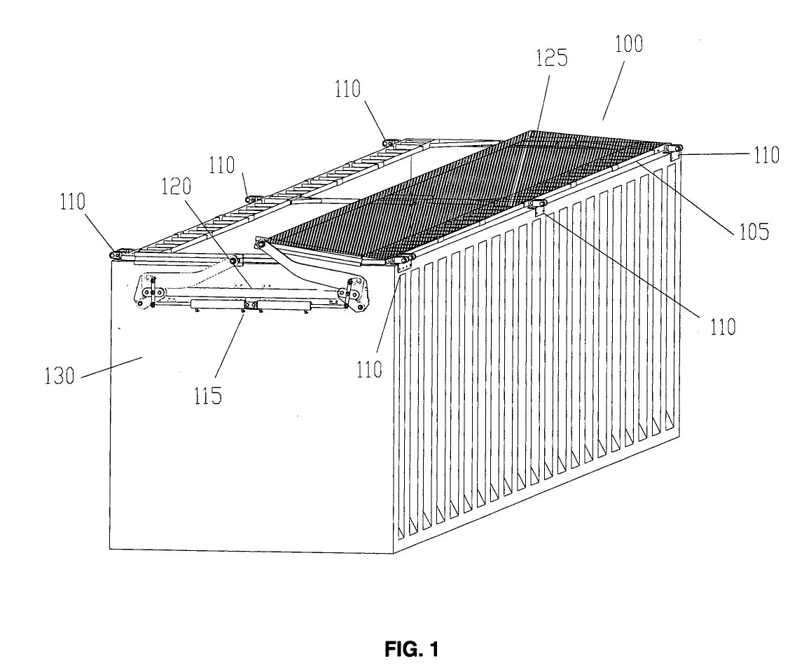

With reference to the drawings, an example embodiment will be described. FIG. 1 is a perspective view of a truck bed/trailer including one example of an apparatus for covering a truck/trailer body 130. The example of the truck bed/trailer in FIG. 1 is illustrated with the truck/trailer body 130 being covered by a lid assembly 100. In this example, the lid assembly 100 is attached to an upper longitudinal edge 105 of the truck/trailer body 130 through hinge brackets 110. The actuator assembly 115 in this example is attached to the front end of the truck bed/trailer body 130 through installation brackets 120. Also illustrated in this example is a lid or flexible tarpaulin 125 that is stretched over the lid assembly 100. When the actuator assembly is activated, the lid or tarpaulin 125 can be moved to cover or uncover the top side of the truck/trailer body 130, as desired.

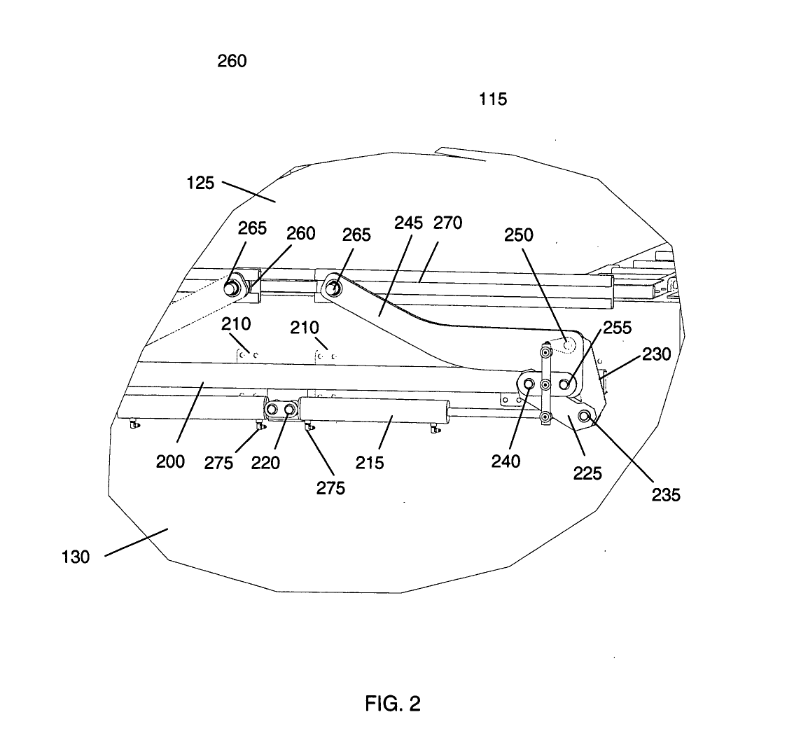

FIG. 2 is a close up view of the actuator assembly 115 in the example illustrated in FIG. 1. The actuator assembly 115 may contain rigid linkages as illustrated in FIG. 2. In this example, a support beam 200 is attached to the truck/trailer body 130 through the installation brackets 210 by fasteners or welding (not shown). The support beam 200 supports the actuator assembly 115 and anchors the actuator assembly 115 to the truck/trailer body 130 and can be any shape or configuration. For example, the support beam 200 may be square or rectangular in shape and may be made out of steel, aluminum or other suitable metal alloy.

As FIG. 2 illustrates, the linear actuator cylinder 215 may be pivotally attached to the support beam 200 by a center pin 220 and may also be pivotally attached to rigid linkages, illustrated in FIG. 2 as a first linkage 225 and a second linkage 230, through a floating pin 235. For example, the linear actuator cylinder 215 may be attached to the support beam 200 at one end via the center pin 220 and may be attached at the other end to a first rigid linkage such as the first linkage 225. Lateral movement of the end of the linear actuator cylinder 215 that is attached to the first linkage 225 may cause movement of the first linkage 225. The first linkage 225, as illustrated in this example of FIG. 2 is pivotally connected to the support beam 200 via middle pin 240 such that movement of the first linkage 225 can be a rotational movement around an axis defined by the middle pin 240. For example, as illustrated in FIG. 2, if the end of the linear actuator cylinder 215 retracts from the first linkage 225, the first linkage 225 may pivot around the middle pin 240 in a clockwise direction. This movement of the first linkage 225 may cause a corresponding movement of a second rigid linkage, such as the second linkage 230, via the connection of the first linkage 225 to the second linkage 230 via the floating pin 235.

The second linkage 230 in this example is pivotally attached to the actuator arm 245 through the arm pin 250 and the actuator arm 245 is pivotally attached to the support beam 200 through the edge pin 255. Hence, in this example, if the second linkage 230 is moved (e.g., through movement of the first linkage 225), the actuator arm may also move through a force exerted from the second linkage 230 through the arm pin. In this example, the actuator arm 245 can pivot around the arm pin 250 as the second linkage 230 moves and the actuator arm 245 may also pivot around the edge pin 255.

Furthermore, a roller 260 may be rotatably mounted to a free end of the actuator arm 245 by roller pin 265. As illustrated in FIG. 2, the free end of the actuator arm 245 may be the opposite end of the actuator arm 245 from the end of the actuator arm that is pivotally connected to the second linkage 230. Also illustrated in this example, the roller 260 may be within a roller track 270 which may be attached to the lid or tarpaulin 125. The roller track 270 can be any shape or configuration. For example, the roller track 270 can be a C-shaped profile to confine the roller 260 internally in the roller track 270, such as a steel or aluminum channel. As the roller moves within the roller track 270, the actuator arm 245 may exert a force on the lid/tarpaulin 125 via the roller track 270 to lift or lower the lid/tarpaulin 125 as described in more detail herein.

The linear actuator fitting 275 may provide the input to the actuator assembly 115 to cause movement of the component parts and subsequent liffing or lowering (i.e., opening and closing) of the lid 125. Thus, the linear actuator fitting 275 can be connected to a power source (not shown) to move the linear actuator cylinder 215 in a desired direction. Any form of power source may be used, such as hydraulic, pneumatic, electrical, manual, etc.

For illustration purposes, the example provided in FIG. 2 provides a power source (not shown) that supplies power to the actuator assembly 115 via the linear actuator fitting 275. The power supplied causes retraction of the linear actuator cylinder 215 such that the distance between the center pin 220 (connected to the support beam 200) and the first linkage 225 is decreased. As the center pin 220 is substantially stationary in this example, the decrease in distance between the center pin 220 and the first linkage 225 is accommodated by movement of the first linkage 225. In this example illustrated in FIG. 2, the first linkage 225 pivots around the middle pin 240 in a clockwise direction. This movement of the first linkage 225 causes movement of the second linkage 230 via the floating pin 235. The second linkage 230 thus pivots around the floating pin 235 upon movement of the first linkage 225 and also exerts a force on the actuator arm 245 via the arm pin 250 to cause movement of the actuator arm 245 and pivoting of the actuator arm 245 around the arm pin 250 relative to the second linkage 230. This movement of the actuator arm 245, in this example, causes further pivoting of the actuator arm 245 around the edge pin 255 and clockwise movement such that the actuator arm is moved toward an upright position.

The movement of the actuator arm 245 causes the roller 260 to slide (and/or roll) within the roller track 270. In this example, the roller 260 moves laterally within the roller track to cause the lid 125 to rise. Power from the power source to extend the length of the linear actuator cylinder 215 causes the reverse movement of the lid in this example (i.e., closing of the lid).

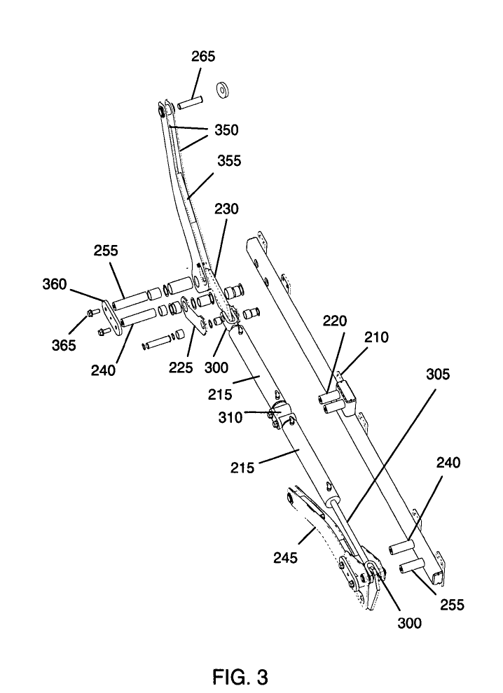

FIG. 3 is an exploded view of the example of the actuator assembly of FIG. 2. FIG. 3 illustrates the underside of the actuator assembly of FIG. 2 for increased clarity. The linear actuator cylinder 215 may contain a U-shaped clevis 300 at the end of piston 305 and tubular bearing housing 310 at the base. As can be seen in this example, the linear actuator cylinder 215 can also include a piston 305 that lengthens or shortens the total length of the linear actuator cylinder 215. A power source (not shown) can supply power to the linear actuator cylinder 215 via the linear actuator fitting 275. This may cause retraction of the piston 305 into the linear actuator cylinder 215 or extension of the piston 305 from the linear actuator cylinder 215 to effect a corresponding movement of the lid 125 (FIG. 2).

Also illustrated in the example of FIG. 3, the actuator arm 245 may be fabricated with two parallel skins 350 attached to each other with a spacer 355, for example. Thus, in one example as illustrated in FIG. 3, the actuator arm may contain a sandwich structure and an internal spacing. The internal spacing may be formed by parallel skins 350 within the actuator arm in the sandwich arrangement, for example. This feature along with the U-shaped clevis 300 allows first and second linkages 225, 230 to be nested into each other. For example, if the actuator arm 245 is retracted to a position overlying the linear actuator cylinder (e.g., as illustrated in FIG. 2), the first linkage 225 and/or the second linkage may be retracted into the space formed by the parallel skins 350. As the actuator arm 245 is moved to an extended position, the first linkage 225 and the second linkage 230 may become extended away from the space between the two parallel skins 350 of the actuator arm 245. Thus, when the lid 125 is closed in this example, the first linkage 225 and/or the second linkage 230 may be nested within the actuator arm, thus saving space and balancing the forces within the structure.

Also in this example, the actuator arm 245 provides stiffness and strength for the cantilever attachment of the roller pin 265. Hence, when the roller 260 moves within the roller track 270, the actuator arm 245 can lift the lid 125. In one example, the roller engages the lid 125 via a roller and track mechanism. In this example, the lid contains a track mechanism that engages the roller such that when the roller moves within the track mechanism of the lid, the lid may be raised, lowered, or otherwise re-positioned. The track mechanism can be formed, for example, as a C-shaped structure that encapsulates the roller such that the roller may slide or roll within the C-shaped structure as described herein.

As FIG. 3 illustrates, the actuator assembly 115 may further include a connector plate 360. The connector plate can be connected to the edge pin 255 and the middle pin 240 via connector plate bolts 365. Through these connections, the actuator arm 245 can be connected to the support beam 200. Because the support beam 200 remains substantially stationary during movement of the components of the actuator assembly 115, the connector plate 360 can provide additional structural stability for the actuator assembly 115 and the actuator arm 245 such that movement of the actuator arm and corresponding movement of the roller 260 within the roller track 270 can cause the proper movement of the lid 125.

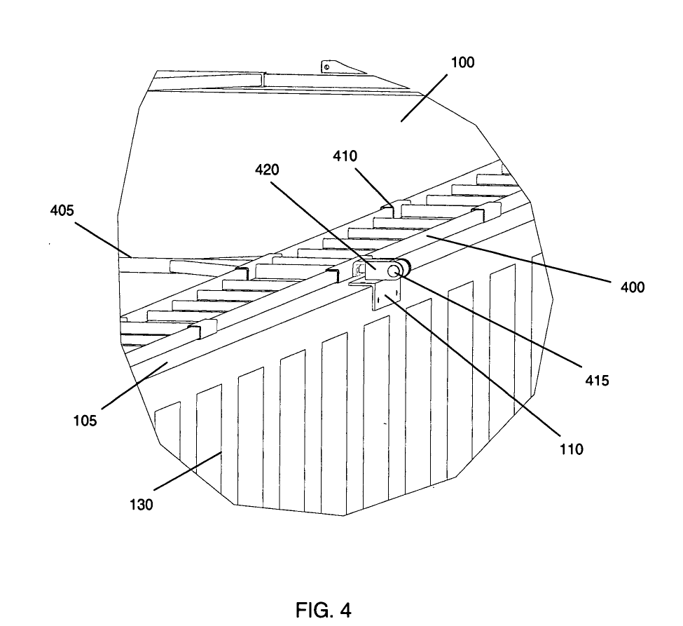

FIG. 4 is a close up view of an example of the hinge and lattice structure of the lid. The lid assembly 100 may be attached to the truck/trailer body 130 in a hinged structure such that the lid assembly 100 can be raised and lowered. In this way, the attached tarpaulin can cover the top opening of the truck/trailer body 130 and can also be removed when desired.

As illustrated in FIG. 4, the lid assembly 100 may include lattice segments 400 and tarp arms 405 and may be attached to the longitudinal edge 105 of the truck/trailer body 130. The lid assembly 100 can be attached via any number (e.g., 2, 3, 4, 5, 6, 7, 8 etc.) of hinge brackets 110 as illustrated in FIG. 4. As such, the lid assembly 100 is pivotally attached via hinges to the truck/trailer body 130 such that the lid assembly 100 may be raised or lowered. In this example, the hinge 420 includes a hinge bracket 110 for attaching to the truck/trailer body 130 and a hinge pin 415. Pivotal movements of the hinge around an axis defined by the hinge pin 415 permits pivotal movement of the lid assembly 100.

The lattice segments 400 of the lid assembly may be connected to each other via tubular connectors 410. The lid assembly 100 including the hinges 420 allows rotation of the lid 125 to any degree of rotational movement. For example, the lid 125 may rotate 900 to result in the lid 125 being positioned in a vertical orientation. The lid 125 may also rotate 180° to position the lid in a horizontal but opened position. The lid 125 may also rotate 270° to position the lid in a vertical and opened position that is located adjacent to the side of the truck/trailer body 130. When the lid is opened 270°, the lid is more conveniently located and is more space efficient. It is understood that lid 125 may also be rotated at various angles between zero and 270° as desired.

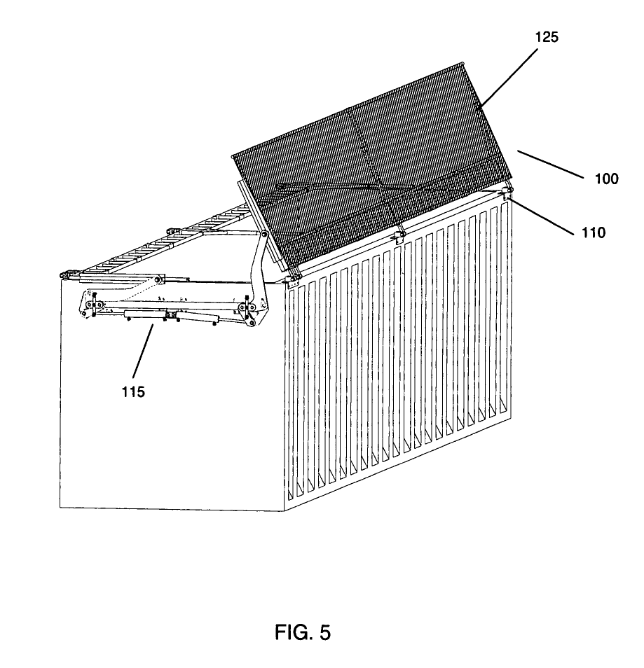

FIG. 5 is a perspective view of the example shown in FIG. 1, but in a semi-covered position. In this example, the lid assembly 100 is elevated such that the tarpaulin 125 that is stretched over the lid assembly 100 is partially opened via the actuator assembly 115.

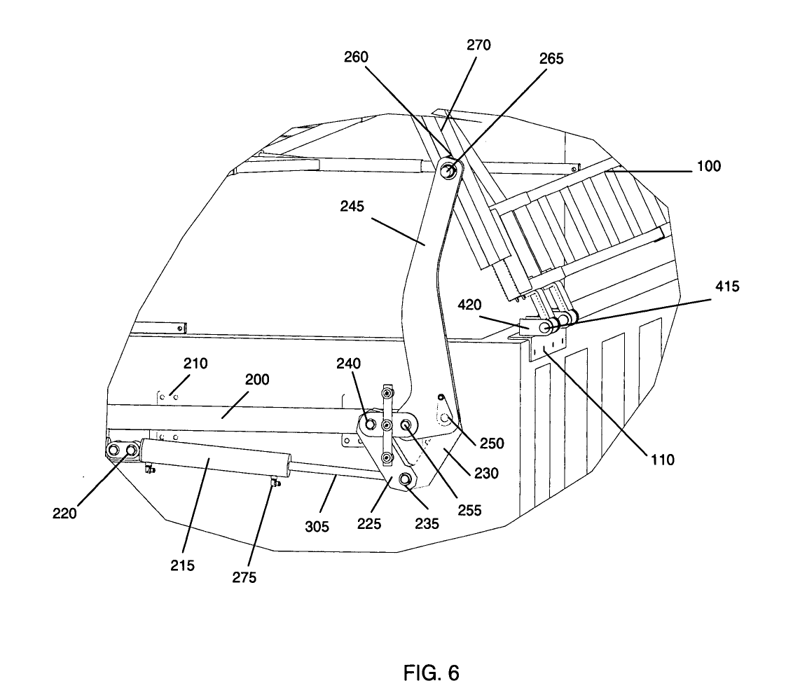

FIG. 6 is a close up view of the example of the actuator assembly in semi-covered position as illustrated in FIG. 5. When the lid assembly 100 is in a closed position in this example, piston 305 of the linear actuator cylinder 215 is in an extended position. When sufficiently high enough pressure or energy to overcome the weight of the lid assembly 100 is applied to the retraction port 275 of the actuator assembly from an energy source (not shown), the linear actuator cylinder 215 may retract (e.g., the piston 305 may retract) such that the distance between the axis of center pin 220 and floating pin 235 is reduced by movement of the first linkage 225 in a pivotal, counter-clockwise movement around the middle pin 240. Movement of the first linkage 225 causes a corresponding movement of the second linkage 230 via the floating pin 235 which also causes movement of the actuator arm 245 via the arm pin 250. The actuator arm 245 thus may rotate on an axis defined by end pin 255 through forces exerted by the second linkage 230 via the arm pin 250.

In this example, clockwise rotation of the first linkage 225 causes a corresponding counter-clockwise rotation of the actuator arm 245 around an axis defined by the first linkage 255. Rotational motion of the actuator arm 245 may be transferred to the lid assembly 100 through roller pin 265 and roller 260. Given that rotation axis of actuator arm 245 and lid assembly 100 are offset, continuity of the motion is provided by a slidable connection between the roller 260 and roller track 270. As FIG. 6 illustrates, the actuator arm rotates to lift the lid assembly 100. The lid assembly 100 pivots rotationally via the hinge 420 around the hinge pin 415. The hinge 420 is connected to the truck/trailer body 130 via the hinge bracket 110. If the lid is rotated 270° around the hinge pin 415, the lid assembly 100 can be conveniently opened and placed in a space-conserving orientation adjacent to the side of the truck/trailer body 130 in a fully-opened position.

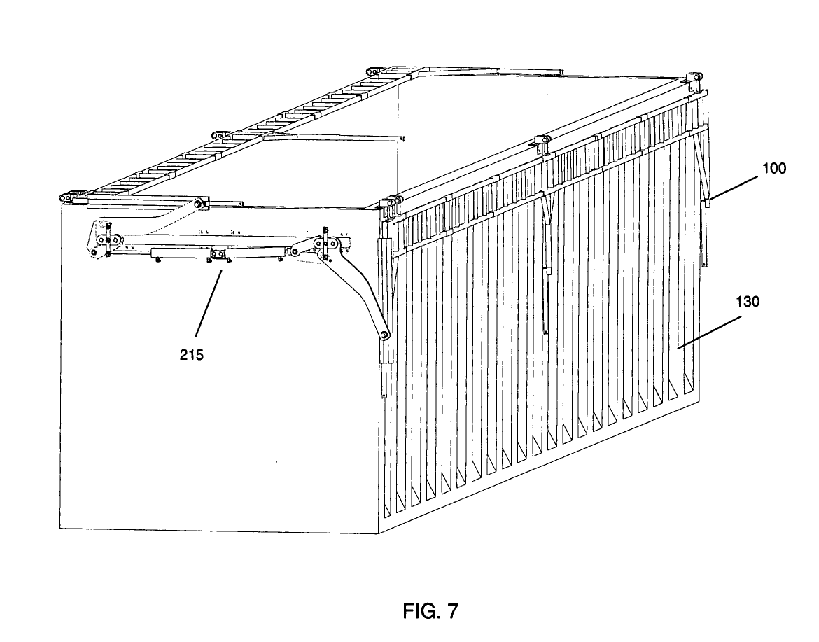

FIG. 7 is a perspective view of a truck bed/trailer including an example of an apparatus as described above for covering a bed of the truck in a fully opened position. In this position, the linear actuator cylinder 215 is retracted and lid assembly 100 is parallel to the truck/trailer body 130. Similarly, the lid assembly 100 on the opposite side can be opened to expose the top portion of the truck/trailer body 130.

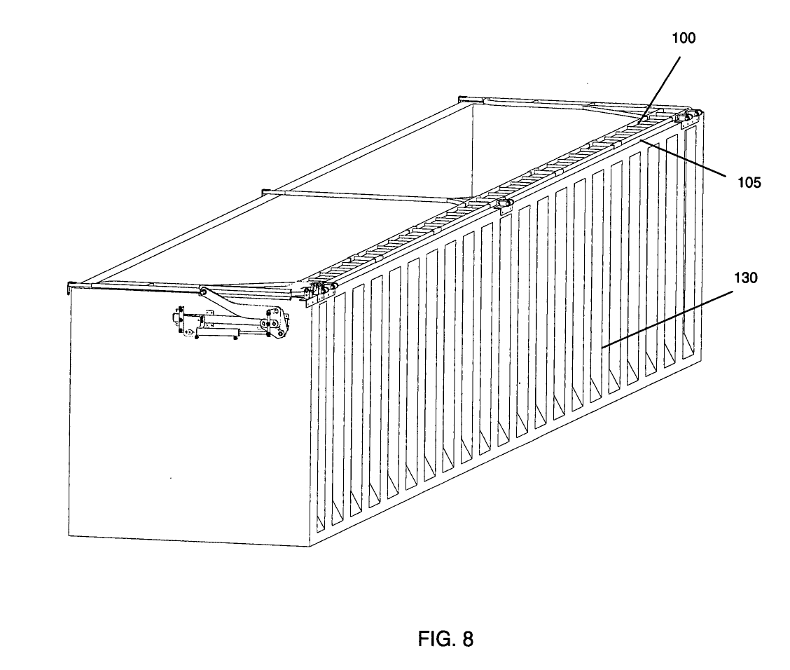

FIG. 8 is a perspective view of a truck bed/trailer including an example of the apparatus with a single lid and actuator. In the example illustrated in FIG. 8, one lid assembly 100 is provided. The lid assembly 100 is attached to the truck/trailer body 130 along one longitudinal edge 105 of the truck-trailer body 130 and extends across to the other longitudinal edge 105 of the truck-trailer body 130.

Any number of lid assemblies may be used in any configuration. For example, two lid assemblies may be used, each attached to a longitudinal side of the truck/trailer body 130. Alternatively, any number of lid assemblies may be used over a longitudinal portion of the truck/trailer body 130. Use of multiple lid assemblies results in a lighter cover that is less susceptible to wind resistance. In addition, with multiple lid assemblies and multiple covers, each lid assembly and cover is more robust and less flimsy than a single lid assembly/cover. Therefore, use of heavier tarpaulin is possible with multiple lid assemblies/covers which can better protect the contents of the open top container (i.e., more impenetrable to the passage of material in or out of the container and more water-resistant). Also, by using a heavier tarpaulin in the multiple lid assembly/cover arrangement, the tarpaulin or cover is less susceptible to negative pressure fields that form through wind and aeronautic effects when the container is in motion. When the container (e.g., truck bed or trailer) is in motion, wind can cause a light tarpaulin to rise up and be sucked away from the container. A heavier tarpaulin is more resistant to these adverse wind effects. In other embodiments, a rigid cover may be used instead of a tarpaulin, such as a cover made of rigid plastic or a lightweight metal.

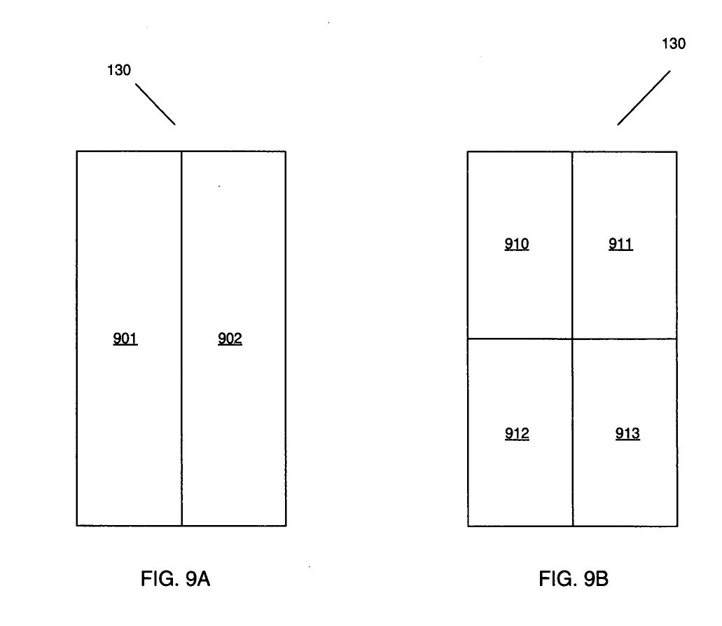

FIG. 9A is a top view of a truck/trailer body 130 with two longitudinal lid assemblies 901, 902, each lid assembly attached to a longitudinal side of the truck/trailer body. FIG. 9B is a top view of a truck/trailer body 130 illustrating an alternative embodiment of four longitudinal lid assemblies 910, 911, 912, 913, each lid assembly being attached to a longitudinal side of the truck/trailer body 130 and covering a longitudinal portion of the truck/trailer body 130. In this example, each lid assembly 910, 911, 912, and 913 covers one-fourth of the opening of truck/trailer body 130.

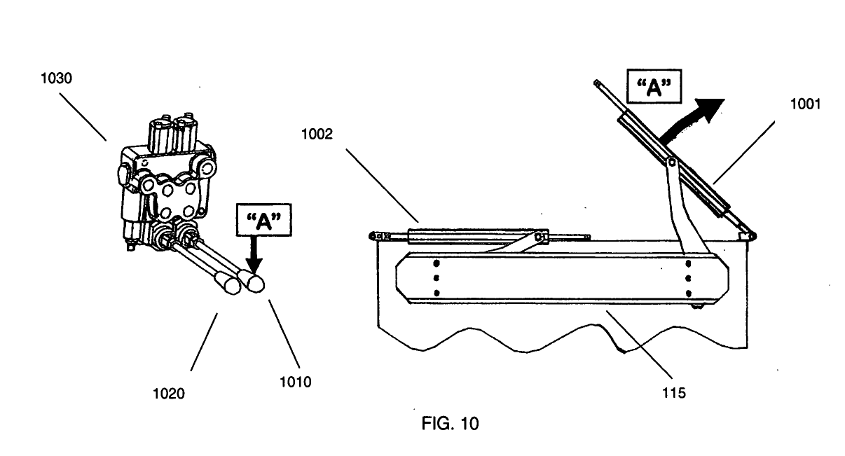

FIG. 10 is a diagram illustrating an example of an apparatus as described above having two lid assemblies. In this example, two lid assemblies 1001, 1002 can be raised and lowered to cover a truck/trailer body 130 individually. Separate levers 1010, 1020 connected to a power source 1030 can be used to control the opening and closing of the respective lid assemblies 1001, 1002. For example, a user can activate lever 1010 corresponding to one of the lid assemblies 1001 (labeled as “A” in this example). When the lever 1010 is activated, power is provided to the actuator assembly on the corresponding side to lift the corresponding lid assembly 1001 as illustrated in FIG. 10.

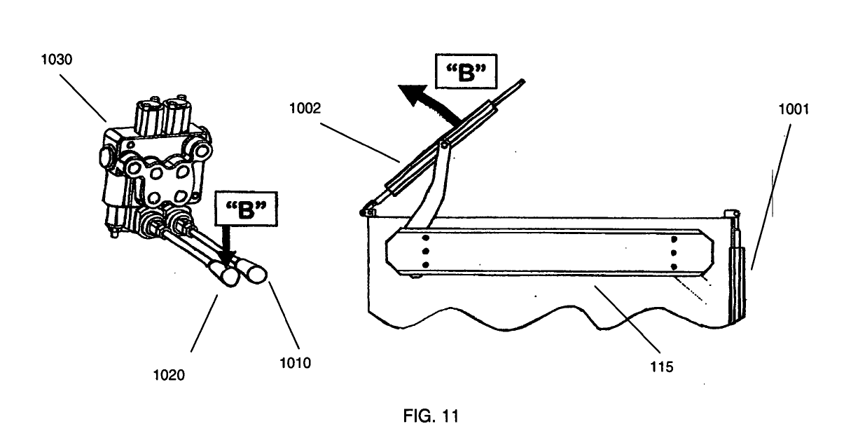

FIG. 11 is a diagram illustrating the example of FIG. 10 in which a second lid assembly 1002 may be raised. In this example, the lid assembly 1001 has been raised and pivoted 270° to uncover the truck/trailer body 130 by activation of the corresponding lever 1010 as described above in FIG. 10. The second lid assembly 1002 may also be raised to uncover the corresponding portion of the truck/trailer body 130 by activation of the corresponding lever 1020. In this example, lever 1020 corresponds to lid assembly 1002 such that activation of lever 1020 provides power to the actuator assembly 115 for the corresponding lid assembly 1002. The lid assembly 1002 is then raised in a similar manner. In this example, multiple lid assemblies are used to cover the top side of the truck/trailer body 130. By using multiple lid assemblies (in this example, two lid assemblies) rather than a single lid assembly, less force is needed to raise the lighter lid assembly resulting in conservation of energy and resources. Further, each of the lid assemblies in the plurality of lid assemblies are smaller than a single lid assembly and are therefore less susceptible to wind shearing forces and other aeronautical forces. Also, the radius of rotation of the lid assemblies for multiple lid assemblies is shorter than the radius of rotation of single lid assemblies, thus enabling opening and closing of the lid assemblies in areas with limited space.

It should be understood that while the forms shown and described above constitute embodiments and features described herein, they are not intended to illustrate all possible forms thereof. It should also be understood that the words used are words of description rather than limitation, and various changes may be made without departing from the spirit and scope of the invention disclosed.

1. An apparatus for covering a top of an open top container, the apparatus comprising:
a lever rotatably attached to a support frame;
an actuator attached to the support frame, the actuator having an extendable and retractable drive member coupled to a first end of the lever, the actuator rotating the lever with respect to the support frame when the drive member extends and retracts; and
a lid assembly having a first end portion adapted to be rotatably attached to the open top container and a second end portion coupled to a second end of the lever, the second end of the lever rotating the second end portion of the lid assembly with respect to the open top container when mounted thereon when the lever rotates;
wherein the lid assembly rotates about the open top container when mounted thereon when the actuator drive member extends and retracts.

2. The apparatus of claim 1 wherein the lid assembly includes a lattice frame.

3. The apparatus of claim 1, wherein the second end portion of the lid assembly is slidably coupled to the second end of the lever.

4. The apparatus of claim 3, wherein the lid assembly second end portion forms a track and the second end of the lever includes a slide member slidably engaging the track.

5. The apparatus of claim 4, wherein the slide member comprises a roller and the track encapsulates the roller in a C-shaped structure.

6. The apparatus of claim 1 wherein the actuator drive member moves in a linear orientation.

7. The apparatus of claim 6 wherein rotation of the lever converts the linear movement of the actuator drive member into rotational movement of the lid assembly.

8. The apparatus of claim 7 wherein the rotational movement of the lid assembly includes rotation of 180 to 270 degrees.

9. The apparatus of claim 1 wherein the lever comprises an actuator arm having a first end and a second end, the actuator arm second end being slidably connected to the lid assembly, the apparatus further comprising:
a first rigid linkage operably connected to the actuator drive member and being pivotally attached to the support frame; and
a second rigid linkage pivotally connected to the first rigid linkage and the actuator arm first end.

10. The apparatus of claim 9 wherein the actuator arm includes two plates forming a sandwich structure and an internal spacing.

11. The apparatus of claim 10 wherein the second rigid linkage is nested within the internal spacing of the sandwich structure of the actuator arm when the lid assembly is in a closed configuration.

12. The apparatus of claim 11 wherein the first rigid linkage is nested within the internal spacing of the sandwich structure of the actuator arm when the lid assembly is in a closed configuration.

13. The apparatus of claim 1 wherein the lid assembly is connected to the support frame by at least one hinge.

14. The apparatus of claim 1 wherein the lid assembly includes a cover that covers the entire surface of the lid assembly.

15. The apparatus of claim 14 wherein the cover is flexible.

16. The apparatus of claim 14 wherein the cover is rigid.

17. An apparatus for covering a top of an open top container, the apparatus comprising:
a first actuator and a second actuator, each attached to the open top container and each being capable of being extended or retracted;
a first lid assembly attached to a first longitudinal aspect of the open top container and operably connected to the first actuator for moving a first cover over the top of the open top container responsive to the first actuator;
a second lid assembly attached to a second longitudinal aspect of the open top container and operably connected to the second actuator for moving a second cover over the top of the open top container responsive to the second actuator.

18. The apparatus of claim 17 further comprising:
a first rigid linkage operatively connected to the first actuator and pivotally connected to the open top container; and
a second rigid linkage operatively connected to the second actuator and pivotally connected to the open top container,
wherein the first rigid linkage rotationally pivots responsive to the first actuator extending or retracting, and wherein the second rigid linkage rotationally pivots responsive to the second actuator extending or retracting.

19. The apparatus of claim 18 further comprising:
a third rigid linkage pivotally connected to the first rigid linkage; and
a fourth rigid linkage pivotally connected to the second rigid linkage.

20. The apparatus of claim 19 further comprising:
a first actuator arm including a first end and a second end, the first actuator arm being pivotally connected to the third rigid linkage at the first end of the first actuator arm, the second end of the first actuator arm including a first roller; and
a second actuator arm including a first end and second end, the second actuator arm being pivotally connected to the fourth rigid linkage at the first end of the second actuator arm, the second end of the second actuator arm including a second roller.

21. The apparatus of claim 20 wherein the first lid assembly includes an engagement for the first roller and the second lid assembly includes an engagement for the second roller, the first roller being slidably connected to the engagement of the first lid assembly and the second roller being slidably connected to the engagement of the second lid assembly.

22. A method for covering a container having an open top, the method comprising:
providing a plurality of lid assemblies for moving a corresponding cover over the open top of the container, the plurality of lid assemblies including at least a first lid assembly pivotally connected to a first side of the open top and a second lid assembly pivotally connected to a second side of the open top; and
driving at least one of the first lid assembly and the second lid assembly so that the at least one of the first lid assembly and the second lid assembly moves over the open top of the container.

23. The method of claim 22 wherein the driving step comprises:
driving the first lid assembly so that the first lid assembly moves over the open top of the container; and
driving the second lid assembly so that the second lid assembly moves over the open top of the container after the first lid assembly moves over the open top of the container.

24. The method of claim 22 wherein the driving step comprises driving the first lid assembly and the second lid assembly substantially so that the first lid assembly and the second lid assembly move over the open top of the container substantially simultaneously.

25. The method of claim 22 wherein the lid assembly comprises a first plurality of hinges for pivotally connecting the first lid assembly to the first side of the open top of the container and a second plurality of hinges for pivotally connecting the second lid assembly to the second side of the open top of the container.

26. The method of claim 22 wherein when the first lid assembly moves over the open top of the container, a first lid assembly pivots around the first side of the open top of the container so that a cover corresponding to the first lid assembly moves over the open top of the container.

27. An apparatus for covering a top of an open top container, the apparatus comprising:
an actuator pivotally connected to a support frame;
a first rigid linkage pivotally connected to the support frame;
a second rigid linkage pivotally connected to the first rigid linkage at a connection point, wherein the actuator is pivotally connected to the connection point;
an actuator arm pivotally connected to the second rigid linkage and pivotally connected to the support frame, the actuator arm including a free end;
a roller rotatably attached to the free end of the actuator arm.
